(19) United States
(12) Patent Application Publication
(10) Pub. No.: US 2026/0151991 A1
(43) Pub. Date: Jun. 4, 2026

(54) FULLY-AUTOMATIC FILM APPLICATOR

(71) Applicant: Jianbo Han, Daozhen Gelao and Miao Autonomous (CN)

(72) Inventor: Jianbo Han, Daozhen Gelao and Miao Autonomous (CN)

(21) Appl. No.: 19/457,501

(22) Filed: Jan. 23, 2026

(30) Foreign Application Priority Data
May 21, 2025 (CN) 202520999927.4

(51) Int. Cl. B32B 37/00; B32B 37/18

(52) U.S. Cl. CPC B32B 37/0053; B32B 37/18; B32B 2457/208

(57) ABSTRACT

A fully-automatic film applicator includes a main body. The main body is provided with a fixing structure, a positioning part and a film rolling mechanism and is also provided with a film tearing mechanism. In use, a mobile phone is fixed by the fixing structure, a mobile phone film is positioned by means of the positioning part, and a working part of the film tearing mechanism is connected to a dust-proof protective film and tears the dust-proof protective film off from a screen film in a rolling manner; and then, the screen film is rolled onto a screen of the mobile phone by means of the film rolling mechanism. The whole process is fully automatic.

### BACKGROUND OF THE INVENTION

### Technical Field

The disclosure relates to the technical field of application of mobile phone films, in particular to a fully-automatic film applicator.

### Description of Related Art

Generally, an unused mobile phone film includes a screen film, a dust-proof protective film and a surface positioning film. The dust-proof protective film is attached to a fitting surface at the bottom of the screen film (i.e., a surface, fitting the screen of a mobile phone, of the screen film). The surface positioning film is attached to an upper surface of the screen film, and positioning holes are formed in four corners of the surface positioning film. The screen film is finally attached to the mobile phone to fulfill a protection effect. With the popularization of consumer electronic products such as smartphones and tablet personal computers, the application of screen films (such as tempered glass films and peep-proof films) to the screens of mobile phone has become a rigid demand of users to protect the screens of the mobile phone.

However, although there have been some film application devices on the market, these film application devices are low in automation, for example, the dust-proof protective film still needs to be torn off manually. Therefore, it is necessary to propose a new solution to solve this problem.

### BRIEF SUMMARY OF THE INVENTION

In view of the defects in the prior art, a main objective of the disclosure is to provide a fully-automatic film applicator to solve the problem mentioned above.

To fulfill the above objective, the disclosure adopts the following technical solution:

A fully-automatic film applicator is used for applying a screen film to a screen of a mobile phone and includes a main body, where the main body is provided with:
a fixing structure, used for automatically fixing the mobile phone;
a positioning part, corresponding to positioning holes of a surface positioning film, the positioning holes of the surface positioning film being engaged with the positioning part during work;
a film tearing mechanism, provided with a working part, which is connected to a dust-proof protective film and used for tearing the dust-proof protective film off from the screen film; and
a film rolling mechanism, used for automatically rolling the screen film onto the screen of the mobile phone.

Preferably, the film tearing mechanism includes a pinch roller set and a first motor for driving the pinch roller set to rotate, and the pinch roller set is used for clamping the dust-proof protective film and is driven by the first motor to roll to tear the dust-proof protective film off from the screen film.

Preferably, the pinch roller set includes a driving roller and a driven roller, and spacing segments are concavely arranged in a middle of the driving roller and a middle of the driven roller.

Preferably, the fixing structure includes a clamping assembly used for clamping left and right sides of the mobile phone, and the clamping assembly includes two clamping jaws and a second motor for controlling the two clamping jaws to be opened and closed.

Preferably, a stop surface is arranged on the main body, the fixing structure includes a pressing member and a third motor for driving the pressing member to move back and forth to be close to/away from the stop surface, and the pressing member works together with the stop surface to press and fix upper and lower sides of the mobile phone.

Preferably, the positioning part includes two positioning pillars corresponding to two positioning holes in one side of the surface positioning film and two barbs corresponding to two positioning holes in the other opposite side of the surface positioning film.

Preferably, recesses, which are concaved inwards, are formed in cross-sections of the positioning pillars, and the recesses are located on sides, facing away from the barbs, of the positioning pillars.

Preferably, a distance between the two positioning pillars is 38 mm, and a distance between the positioning pillars and the corresponding barbs is 217 mm.

Preferably, the film rolling mechanism includes a movable base and two linear gear tracks respectively arranged on two sides of the main body, the movable base is located between the two linear gear tracks, a roller, an elastic element, a movable drive rod and a fourth motor are arranged on the movable base, a driving gear is arranged on the fourth motor, a driven gear is arranged on the movable drive rod, the driven gear is meshed with the driving gear, connecting gears are arranged at two ends of the movable drive rod, the two connecting gears are respectively meshed with the corresponding linear gear tracks, the roller abuts against the surface positioning film, and the elastic element is used for applying a force to the roller to make the roller always have a tendency to move towards the surface positioning film.

Compared with the prior art, the disclosure has obvious advantages and beneficial effects. Specifically, according to the above technical solution,

The film tearing mechanism is additionally arranged and provided with the working part, which is connected to the dust-proof protective film and used for tearing the dust-proof protective film off from the screen film in a rolling manner, and the fixing structure, the positioning part and the film rolling mechanism are all automatic (in the prior art, these structures are automatic in different forms), such that fully-automatic film application is realized. During work, first, the mobile phone is fixed by the fixing structure; then, a mobile phone film is positioned by means of the positioning part; after that, the film tearing mechanism tears the dust-proof protective film off from the mobile phone film; then, the screen film is rolled onto the screen of the mobile phone by means of the film rolling mechanism; and finally, users tear the surface positioning film off from the screen film and take out the mobile phone. The whole process is fully automatic and extremely convenient to implement.

To more clearly expound the structural features and effects of the disclosure, the disclosure is described in detail below in conjunction with accompanying drawings and specific embodiments.

### BRIEF DESCRIPTION OF THE SEVERAL VIEWS OF THE DRAWINGS

FIG. 1 is an overall structural view according to one embodiment of the disclosure.

FIG. 2 is a partial structural view according to one embodiment of the disclosure.

FIG. 3 is an enlarged view of part A in FIG. 2.

FIG. 4 is an enlarged view of part B in FIG. 2.

FIG. 5 is a partial structural view, from another perspective, according to one embodiment of the disclosure.

FIG. 6 is a structural view in a case where a mobile phone is fixed according to one embodiment of the disclosure.

FIG. 7 is a structural view in a case where a mobile phone film is positioned according to one embodiment of the disclosure.

FIG. 8 is an enlarged view of part C in FIG. 7.

FIG. 9 is another partial structural view according to one embodiment of the disclosure.

FIG. 10 is a partial enlarged structural view according to one embodiment of the disclosure.

FIG. 11 is yet another partial structural view according to one embodiment of the disclosure.

FIG. 12 is yet another partial structural view, from another perspective, according to one embodiment of the disclosure.

FIG. 13 is a schematic diagram of a fixing structure according to one embodiment of the disclosure.

FIG. 14 is a schematic diagram of a film tearing mechanism according to one embodiment of the disclosure.

FIG. 15 is a schematic diagram of a film rolling mechanism according to one embodiment of the disclosure.

FIG. 16 is a schematic partial diagram of the film rolling mechanism according to one embodiment of the disclosure.

### REFERENCE SIGNS

10, main body; 11, stop surface; 20, fixing structure; 21, clamping assembly; 211, clamping jaw; 212, second motor; 22, pressing member; 23, third motor; 30, positioning part; 31, positioning pillar; 311, recess; 32, barb; 40, film tearing mechanism; 41, first motor; 42, driving roller; 43, driven roller; 44, spacing segment; 50, film rolling mechanism; 51, movable base; 52, linear gear track; 53, roller; 54, elastic element; 55, movable drive rod; 56, fourth motor; 57, driving gear; 58, connecting gear; 59, driven gear; 60, mobile phone; 61, surface positioning film; 62, positioning hole; 63, dust-proof protective film.

### DETAILED DESCRIPTION OF THE INVENTION

To better clarify the objectives, technical solutions and advantages of the disclosure, the disclosure is described in further detail below in conjunction with accompanying drawings and embodiments. It should be understood that the specific embodiments described here are merely used for explaining the disclosure rather than limiting the disclosure.

It should be noted that when one element is referred to as being “fixed to” the other element, it may be located on the other element directly or by means of an intermediate element. When one element is referred to as being “connected to” the other element, it may be connected to the other element directly or by means of an intermediate element. Terms “vertical”, “horizontal”, “left” and “right” and similar expressions used here are merely for the purpose of description.

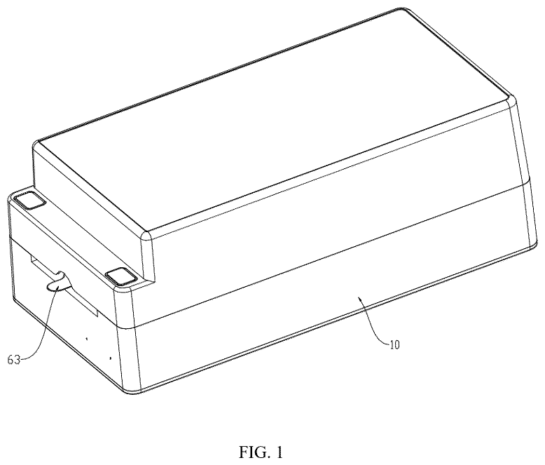

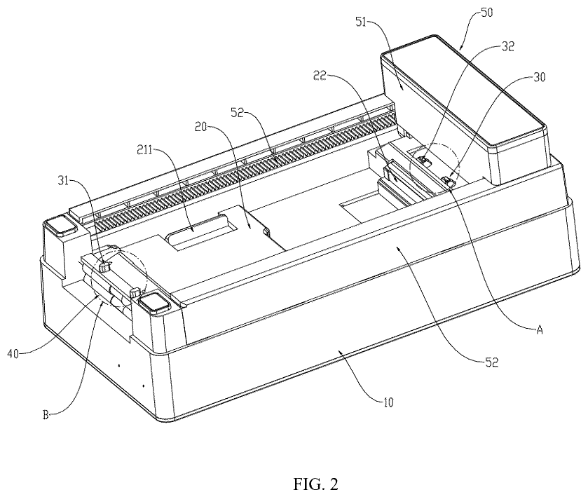

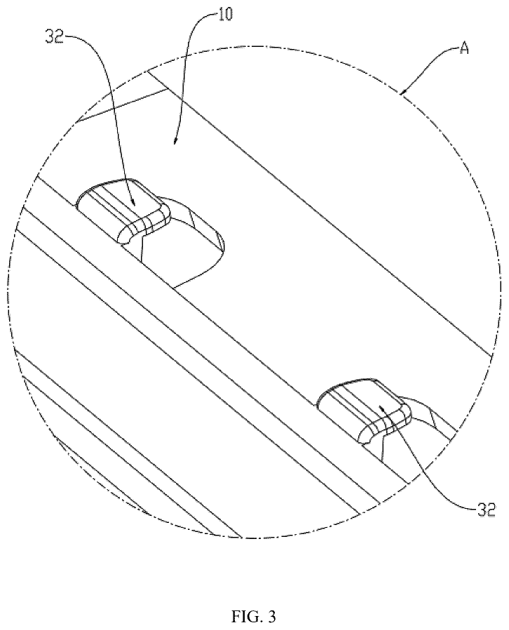

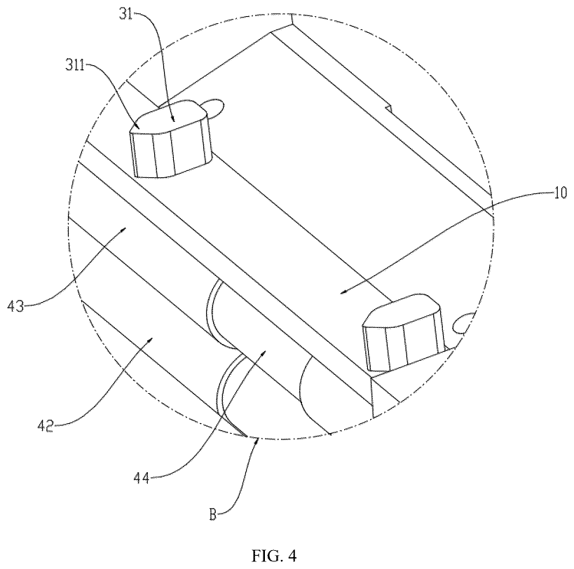

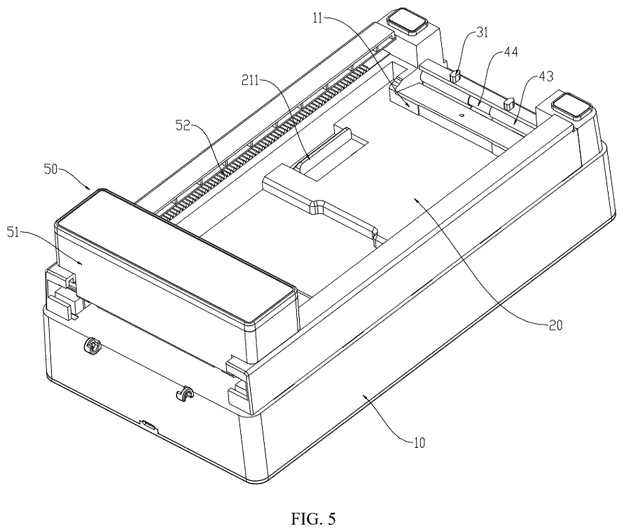

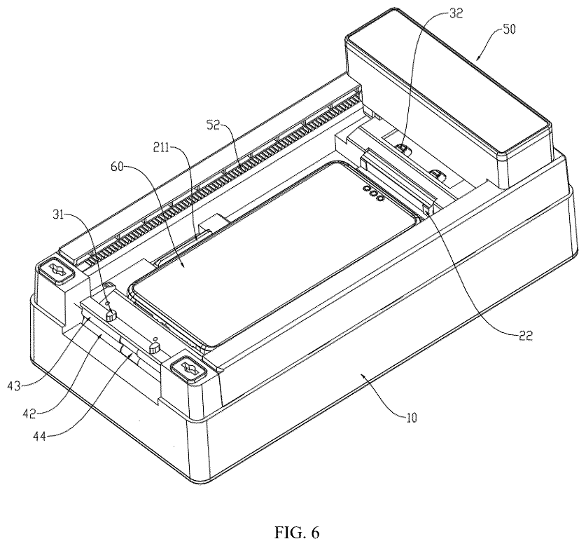

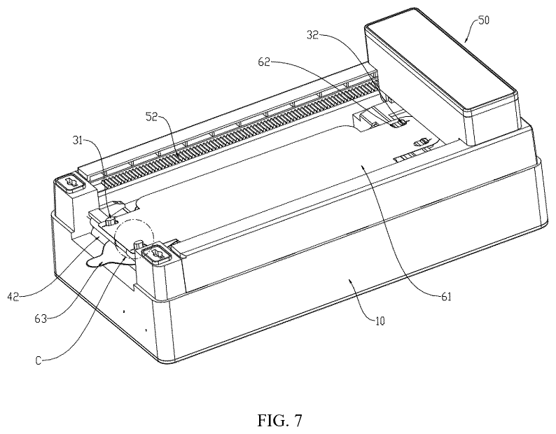

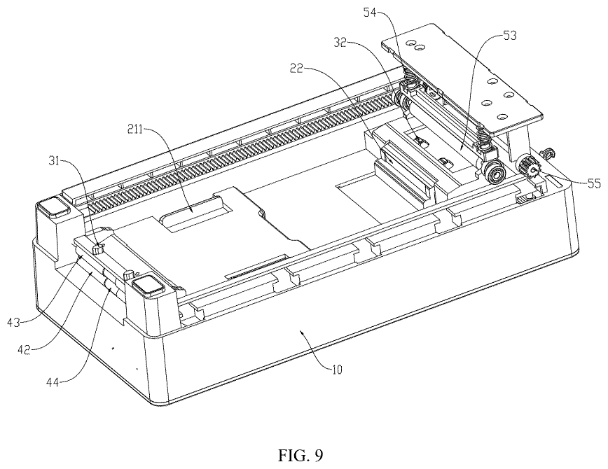

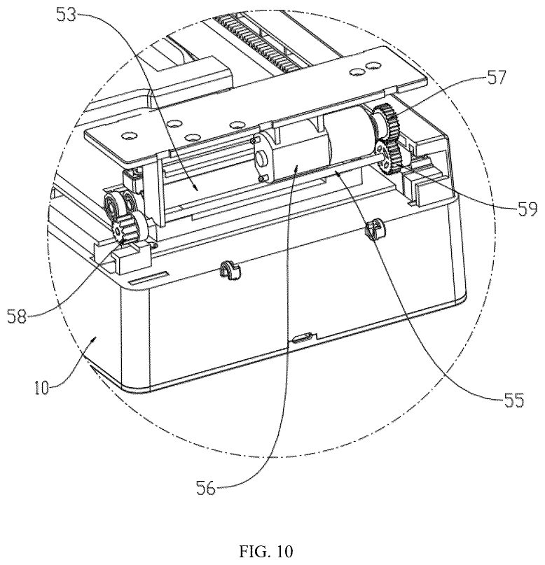

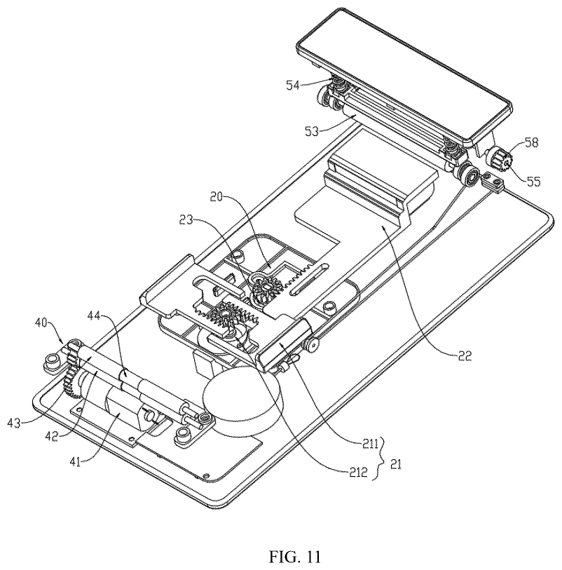

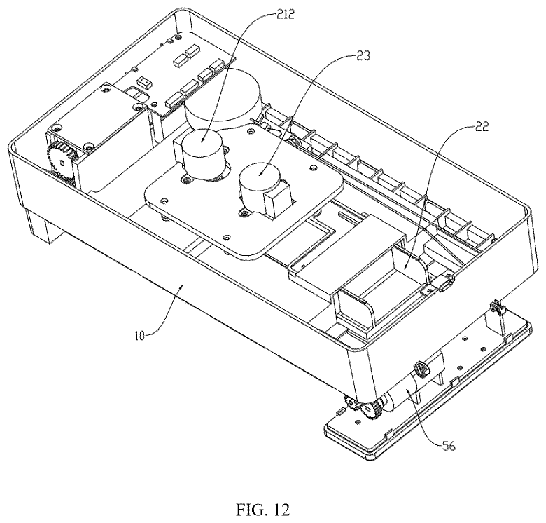

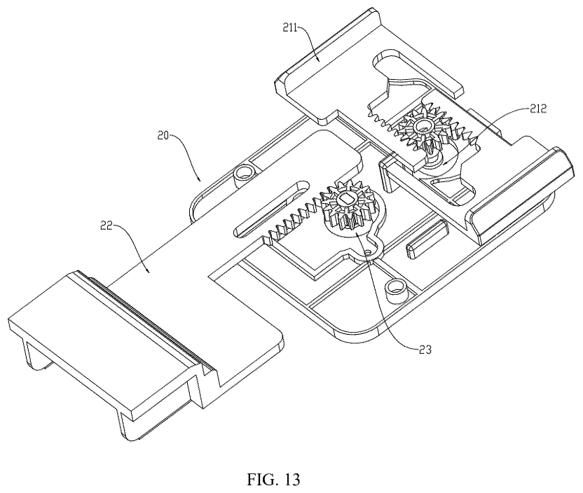

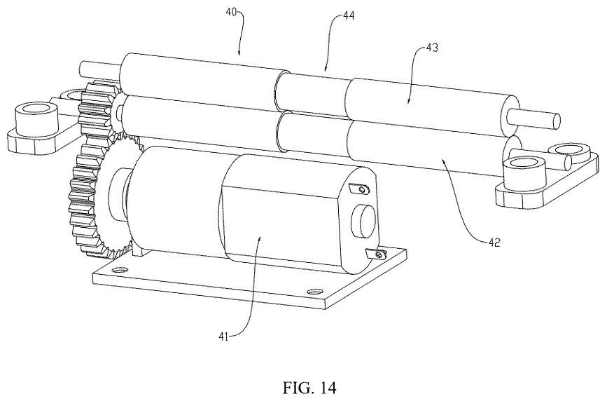

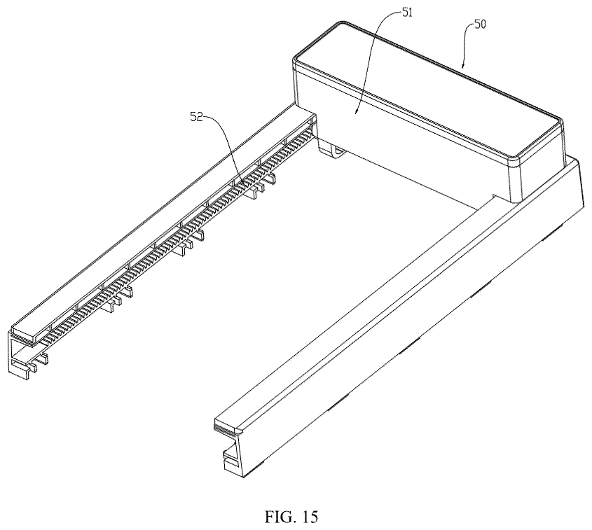

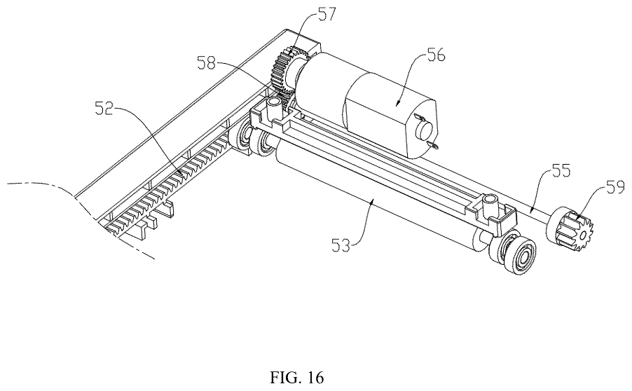

Referring to FIGS. 1-16, the embodiments of the disclosure provide a fully-automatic film applicator, which is used for applying a screen film to a screen of a mobile phone 60. The fully-automatic film applicator includes a main body 10. The main body 10 is provided with:
a fixing structure 20, used for automatically fixing the mobile phone 60;
a positioning part 30, corresponding to positioning holes 62 of a surface positioning film 61, the positioning holes 62 of the surface positioning film 61 being engaged with the positioning part 30 during work;
a film tearing mechanism 40, provided with a working part, which is connected to a dust-proof protective film 63 and used for tearing the dust-proof protective film 63 off from the screen film in a rolling manner; and
a film rolling mechanism 50, used for automatically rolling the screen film onto the screen of the mobile phone 60.

The film tearing mechanism 40 is additionally arranged and provided with the working part, which is connected to the dust-proof protective film 63 and used for tearing the dust-proof protective film 63 off from the screen film in a rolling manner, and the fixing structure 20, the positioning part 30 and the film rolling mechanism 50 are all automatic, such that fully-automatic film application is realized. During work, first, the mobile phone 60 is fixed by the fixing structure 20; then, a mobile phone film is positioned by means of the positioning part 30; after that, the film tearing mechanism 40 tears the dust-proof protective film 63 off from the mobile phone film; then, the screen film is rolled onto the screen of the mobile phone 60 by means of the film rolling mechanism 50; and finally, users tear the surface positioning film 61 off from the screen film and take out the mobile phone 60. The whole process is fully automatic and extremely convenient to implement.

Further, the film tearing mechanism 40 includes a pinch roller set and a first motor 41 for driving the pinch roller set to rotate, the pinch roller set is used for clamping the dust-proof protective film 63 and is driven by the first motor 41 to roll to tear the dust-proof protective film 63 off from the screen film. During work, after the mobile phone 60 is fixed by the fixing structure 20 and the mobile phone film is positioned by means of the positioning part 30, a head end of the dust-proof protective film 63 is clamped in the pinch roller set by users; then, the pinch roller set is driven by the first motor 41 to rotate to clamp the dust-proof protective film 63 and pull the dust-proof protective film 63 outwards, such that the dust-proof protective film 63 is torn off from the screen film. Of course, in some other embodiments, only one working roller may be used for tearing off the film. For example, the head end of the dust-proof protective film 63 is fixed to a specific circumferential position of the working roller, and when the working roller rotates, the dust-proof protective film 63 is torn off from the screen film and wound around the working roller. In addition to this, the dust-proof protective film 63 may be torn off from the screen film in other ways, which will not be detailed here.

Further, the pinch roller set includes a driving roller 42 and a driven roller 43, and spacing segments 44 are concavely arranged in the middle of the driving roller 42 and the middle of the driven roller 43. By means of the spacing segments 44, the dust-proof protective film 63 may be clamped more reliably by the pinch roller set, thus guaranteeing the film tearing effect.

Further, the fixing structure 20 includes a clamping assembly 21 used for clamping left and right sides of the mobile phone 60, and the clamping assembly 21 includes two clamping jaws 211 and a second motor 212 for controlling the two clamping jaws 211 to be opened and closed. The clamping assembly 21 may prevent the mobile phone 60 from moving leftwards and rightwards and keep the center line of the mobile phone 60 unchanged in the left-right direction, thus guaranteeing the accuracy of the position of the mobile phone 60.

Further, a stop surface 11 is arranged on the main body 10, the fixing structure 20 includes a pressing member 22 and a third motor 23 for driving the pressing member 22 to move back and forth to be close to/away from the stop surface 11, and the pressing member 22 works together with the stop surface 11 to press and fix upper and lower sides of the mobile phone 60. By adopting such a fixing method, the movement direction of the film tearing mechanism 40 and the film rolling mechanism 50 during work is the same as the up-down direction of the mobile phone 60, such that the stability of the mobile phone 60 is guaranteed. In actual use, users place the mobile phone 60 between the clamping jaws 211, and the clamping jaws 211 are driven by the second motor 212 to clamp the mobile phone 60; then, the pressing member 22 is driven by the third motor 23 to move towards the stop surface 11 to press the mobile phone 60 together with the stop surface 11, such that the mobile phone 60 is fixed by the fixing structure 20.

Further, the positioning part 30 includes two positioning pillars 31 corresponding to two positioning holes 62 in one side of the surface positioning film 61 and two barbs 32 corresponding to two positioning holes 62 in the other opposite side of the surface positioning film 61. When the mobile phone film is positioned, two of the positioning holes 62 of the surface positioning film 61 are engaged with the two barbs 32, and then the other two positioning holes 62 are engaged with the positioning pillars 31, such that positioning is easy and reliable.

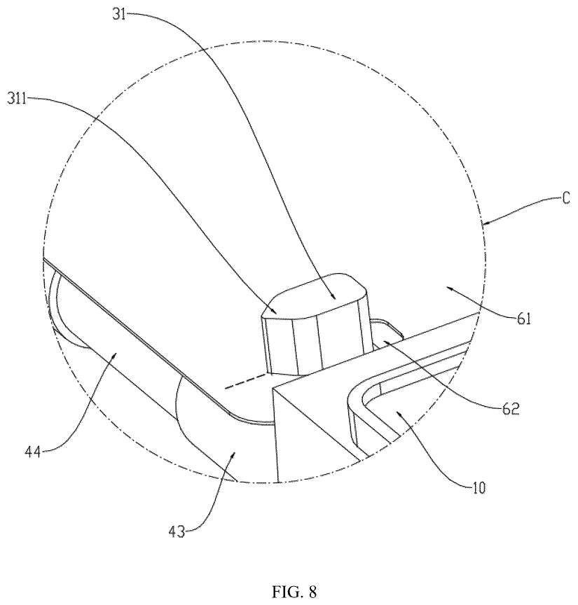

Further, recesses 311, which are concaved inwards, are formed in cross-sections of the positioning pillars 31, and the recesses 311 are located on sides, facing away from the barbs 32, of the positioning pillars 31. Because the recesses 311 are concaved inwards, when the corresponding positioning holes 62 of the surface positioning film 61 are engaged with the positioning pillars 32, inner walls of the corresponding positioning holes 62 will come into contact with tips of the recesses 311, and spaces are reserved between two sides of the recesses 311 and the corresponding positioning holes 62 to prevent the positioning holes 62 from being in contact with the two sides of the recesses 311, such that the surface positioning film 61 may be easily removed from the positioning pillars 31 under the condition that the positioning effect of the mobile phone film is guaranteed; because spaces are reserved between the positioning holes 62 and the two sides of the recesses 311, when the surface positioning film 61 is removed from the positioning pillars 31, the positioning holes 62 may deform adaptively to some extent, and then the surface positioning films 61 may be removed easily and conveniently. In addition, it should be noted that, as shown in FIG. 8, in actual use, dotted lines for tearing open the positioning holes 62 are arranged on the surface positioning film 61, and when the corresponding positioning holes 62 need to be disengaged from the positioning pillars 31 after film application, the positioning holes 62 may be torn open directly along the dotted lines, such that the surface positioning film 61 may be removed more conveniently.

Further, a distance between the two positioning pillars 31 is 38 mm, and a distance between the positioning pillars 31 and the corresponding barbs 32 is 217 mm.

Further, the film rolling mechanism 50 includes a movable base 51 and two linear gear tracks 52 respectively arranged on two sides of the main body 10, the movable base 51 is located between the two linear gear tracks 52, a roller 53, an elastic element 54, a movable drive rod 55 and a fourth motor 56 are arranged on the movable base 51, a driving gear 57 is arranged on the fourth motor 56, a driven gear 59 is arranged on the movable drive rod 55, the driven gear 59 is meshed with the driving gear 57, connecting gears 58 are arranged at two ends of the movable drive rod 55, the two connecting gears 58 are respectively meshed with the corresponding linear gear tracks 52, the roller 53 abuts against the surface positioning film 61, and the elastic element 54 is used for applying a force to the roller 53 to make the roller 53 always have a tendency to move towards the surface positioning film 61. In actual use, after the film (the dust-proof protective film 63) is torn off, a fitting surface of the screen film faces the screen of the mobile phone 60, the movable base 51 is driven by the fourth motor 56 to move in the up-down direction of the mobile phone 60, the roller 53 tightly presses against the surface positioning film 61 under the action of the elastic element 54, at this moment, the screen film is attached to the screen of the mobile phone 60, and with the movement of the movable base 51, the whole screen film will be rolled to remove bubbles, such that film application is completed.

The above embodiments are merely preferred ones of the disclosure and are not intended to limit the disclosure. Any modifications, equivalent substitutions and improvements made on the basis of the principle of the disclosure should fall within the protection scope of the disclosure.

What is claimed is:

1. A fully-automatic film applicator, used for applying a screen film to a screen of a mobile phone (60), comprising a main body (10), wherein the main body (10) is provided with:
a fixing structure (20), used for automatically fixing the mobile phone (60);
a positioning part (30), corresponding to positioning holes (62) of a surface positioning film (61), the positioning holes (62) of the surface positioning film (61) being engaged with the positioning part (30) during work;
a film tearing mechanism (40), provided with a working part, which is connected to a dust-proof protective film (63) and used for tearing the dust-proof protective film (63) off from the screen film; and
a film rolling mechanism (50), used for automatically rolling the screen film onto the screen of the mobile phone (60).

2. The fully-automatic film applicator according to claim 1, wherein the film tearing mechanism (40) comprises a pinch roller set and a first motor (41) for driving the pinch roller set to rotate, and the pinch roller set is used for clamping the dust-proof protective film (63) and is driven by the first motor (41) to roll to tear the dust-proof protective film (63) off from the screen film.

3. The fully-automatic film applicator according to claim 2, wherein the pinch roller set comprises a driving roller (42) and a driven roller (43), and spacing segments (44) are concavely arranged in a middle of the driving roller (42) and a middle of the driven roller (43).

4. The fully-automatic film applicator according to claim 1, wherein the fixing structure (20) comprises a clamping assembly (21) used for clamping left and right sides of the mobile phone (60), and the clamping assembly (21) comprises two clamping jaws (211) and a second motor (212) for controlling the two clamping jaws (211) to be opened and closed.

5. The fully-automatic film applicator according to claim 1, wherein a stop surface (11) is arranged on the main body (10), the fixing structure (20) comprises a pressing member (22) and a third motor (23) for driving the pressing member (22) to move back and forth to be close to/away from the stop surface (11), and the pressing member (22) works together with the stop surface (11) to press and fix upper and lower sides of the mobile phone (60).

6. The fully-automatic film applicator according to claim 4, wherein a stop surface (11) is arranged on the main body (10), the fixing structure (20) comprises a pressing member (22) and a third motor (23) for driving the pressing member (22) to move back and forth to be close to/away from the stop surface (11), and the pressing member (22) works together with the stop surface (11) to press and fix upper and lower sides of the mobile phone (60).

7. The fully-automatic film applicator according to claim 1, wherein the positioning part (30) comprises two positioning pillars (31) corresponding to two said positioning holes (62) in one side of the surface positioning film (61) and two barbs (32) corresponding to two said positioning holes (62) in the other opposite side of the surface positioning film (61).

8. The fully-automatic film applicator according to claim 7, wherein recesses (311), which are concaved inwards, are formed in cross-sections of the positioning pillars (31), and the recesses (311) are located on sides, facing away from the barbs (32), of the positioning pillars (31).

9. The fully-automatic film applicator according to claim 8, wherein a distance between the two positioning pillars (31) is 38 mm, and a distance between the positioning pillars (31) and the corresponding barbs (32) is 217 mm.

10. The fully-automatic film applicator according to claim 1, wherein the film rolling mechanism (50) comprises a movable base (51) and two linear gear tracks (52) respectively arranged on two sides of the main body (10), the movable base (51) is located between the two linear gear tracks (52), a roller (53), an elastic element (54), a movable drive rod (55) and a fourth motor (56) are arranged on the movable base (51), a driving gear (57) is arranged on the fourth motor (56), a driven gear (59) is arranged on the movable drive rod (55), the driven gear (59) is meshed with the driving gear (57), connecting gears (58) are arranged at two ends of the movable drive rod (55), the two connecting gears (58) are respectively meshed with the corresponding linear gear tracks (52), the roller (53) abuts against the surface positioning film (61), and the elastic element (54) is used for applying a force to the roller (53) to make the roller (53) always have a tendency to move towards the surface positioning film (61).
